(19) United States
(12) Patent Application Publication
(10) Pub. No.: US 2011/0167106 A1
(43) Pub. Date: Jul. 7, 2011

(54) COMMUNICATION TERMINAL APPARATUS, PROGRAM, INFORMATION PROCESSING SYSTEM, AND METADATA PROVIDING SERVER

(75) Inventors: Kazuko YAMADA, Tokyo (JP); Atsushi Okamori, Tokyo (JP); Mikita Yasuda, Kanagawa (JP); Masahiko Naito, Tokyo (JP)

(73) Assignee: Sony Corporation, Tokyo (JP)

(21) Appl. No.: 12/973,256

(22) Filed: Dec. 20, 2010

(30) Foreign Application Priority Data
Jan. 5, 2010 (JP) 2010-000604

(51) Int. Cl. G06F 15/16; G06F 17/30

(52) U.S. Cl. 709/203; 707/769; 707/E17.108

(57) ABSTRACT

There is provided a communication terminal apparatus including a position information acquisition section which acquires position information indicating a current position, a velocity calculation section which calculates a moving velocity based on variations in amount and time of the position information acquired by the position information acquisition section, and a metadata acquisition section which determines a reference point to be a reference of an acquisition area of position metadata based on the position information and the moving velocity, determines an area size indicating a size of the acquisition area depending on the moving velocity, and acquires position metadata within an acquisition area specified based on the reference point and the area size from a metadata providing server that provides position metadata.

### BACKGROUND OF THE INVENTION

1. Field of the Invention

The present invention relates to a communication terminal apparatus, a program, an information processing system, and a metadata providing server, and particularly to a communication terminal apparatus, a program, an information processing system, and a metadata providing server which are used in order for a communication terminal apparatus that acquires position metadata from a metadata providing server to efficiently acquire the position metadata.

2. Description of the Related Art

In recent years, services which uses a current position of a user acquired by a device for acquiring position information (e.g. GPS (Global Positioning System) receiver) have been in widespread use. In the past, such a service mainly provided a route from a current position of a user to a destination on a map, as a car navigation system mounted on a vehicle. Currently, however, more devices for acquiring position information are mounted on various portable devices such as a mobile phone, a portable game device, a PDA, a PC, and a camera.

Among the devices, there are those which provide the user with position metadata including map information or POI (Point Of Interest) information, which is information related to a point on a map, by downloading the position metadata from an online metadata providing server via a network. However, a capacity of a storage device for such a device to store the position metadata and a band of network used for downloading the position metadata may not be sufficiently ensured all the time. In addition, pieces of information associated with a position are increasing every year. Consequently, there is desired a method of efficiently acquiring position metadata.

Accordingly, for example, JP-A-2009-105882 discloses a device capable of updating only minimum data by dividing map data into files each specific to a particular area and, in addition, allowing road data to be located in another layer, to thereby make it possible to update data with respect to each file and with respect to each layer. Further, JP-A-2009-105882 also suggests a method of preferentially downloading map information of a place in a travelling direction of the device or map information of a place which the road being driven on leads to.

### SUMMARY OF THE INVENTION

However, there was an issue that, although the size of area of necessary position metadata should be different depending on a moving velocity of a user, this point was not taken into account, and hence, the size of the position metadata to be acquired was the same even in the case where the user is travelling on foot and in the case where the user is travelling by train, therefore it was highly likely that position metadata of a redundantly large region was acquired when the moving velocity is low.

In light of the foregoing, it is desirable to provide a communication terminal apparatus, a program, an information processing system, and a metadata providing server, which are novel and improved, and which are used in order for a communication terminal apparatus to efficiently acquire position metadata.

According to an embodiment of the present invention, there is provided a communication terminal apparatus which includes a position information acquisition section which acquires position information indicating a current position, a velocity calculation section which calculates a moving velocity from variations in amount and time of the position information acquired by the position information acquisition section, and a metadata acquisition section which determines a reference point to be a reference of an acquisition area of position metadata based on the position information and the moving velocity, determines an area size indicating a size of the acquisition area depending on the moving velocity, and acquires position metadata within an acquisition area specified based on the reference point and the area size from a metadata providing server that provides position metadata.

According to such a configuration, the size of the position metadata acquisition area can be changed depending on the moving velocity of the communication terminal apparatus on a case-by-case basis. Therefore, the position metadata can be efficiently acquired and the responsiveness of a screen which the user is provided with is also enhanced.

Further, the position metadata may include at least information of a map and spot information which is information related to a point on the map. The metadata acquisition section may selectively acquire the spot information from among pieces of spot information within the acquisition area based on at least one of the position information and user information registered beforehand.

Further, the metadata acquisition section may selectively acquire the spot information of a necessary category from among the pieces of spot information within the acquisition area based on an attribute of a region specified by the position information acquired by the position information acquisition section.

Further, the position metadata may further include user meta-information which is associated with a position and the user information. The metadata acquisition section may estimate transportation means of a user based on the moving velocity calculated by the velocity calculation section and the position information acquired by the position information acquisition section, and may selectively acquire position metadata from within the acquisition area depending on the estimated transportation means.

Further, the metadata acquisition section may selectively acquire the position metadata from within the acquisition area in accordance with preference information included in the user information registered beforehand or preference information based on action history information of the user.

According to an embodiment of the present invention, there is provided a program for causing a computer to function as a position information acquisition section which acquires position information indicating a current position, a velocity calculation section which calculates a moving velocity from variations in amount and time of the position information acquired by the position information acquisition section, and a metadata acquisition section which determines a reference point to be a reference of an acquisition area of position metadata based on the position information and the moving velocity, determines an area size indicating a size of the acquisition area depending on the moving velocity, and acquires position metadata within an acquisition area specified by the reference point and the area size from a metadata providing server that provides position metadata.

Further, according to an embodiment of the present invention, there is provided an information processing system which includes a communication terminal apparatus including a position information acquisition section which acquires position information indicating a current position, a velocity calculation section which calculates a moving velocity from variations in amount and time of the position information acquired by the position information acquisition section, and a metadata acquisition section which determines a reference point to be a reference of an acquisition area of position metadata based on the position information and the moving velocity, determines an area size indicating a size of the acquisition area depending on the moving velocity, and acquires position metadata within an acquisition area specified by the reference point and the area size from a metadata providing server that provides position metadata, and a metadata providing server including a metadata search section which searches position metadata in accordance with a request of the metadata acquisition section, and a metadata providing section which provides the communication terminal apparatus with position metadata, which is a result searched by the metadata search section.

Further, according to an embodiment of the present invention, there is provided a metadata providing server which includes a metadata search section which determines an area size indicating a size of an acquisition area of position metadata depending on a moving velocity of a communication terminal apparatus received from the communication terminal apparatus, and searches position metadata within an acquisition area specified based on a reference point received from the communication terminal apparatus and the area size, and a metadata providing section which provides the communication terminal apparatus with position metadata, which is a result searched by the metadata search section.

According to the embodiments of the present invention described above, it becomes possible to adjust an area size of position metadata to be acquired depending on a moving velocity and to efficiently acquire position metadata.

### BRIEF DESCRIPTION OF THE DRAWINGS

FIG. 1 is a configuration diagram of an information processing system according to an embodiment of the present invention;

FIG. 2 is an explanatory diagram illustrating an example of a setting screen of position metadata;

FIG. 3 is an explanatory diagram illustrating an example of position metadata;

FIG. 4 is an explanatory diagram illustrating another example of position metadata;

FIG. 5 is a functional block diagram of the information processing system;

FIG. 6 is an explanatory diagram illustrating a method of acquiring position metadata in the case where a moving velocity of a communication terminal apparatus is constant;

FIG. 7 is an explanatory diagram illustrating a method of acquiring position metadata in the case where the moving velocity of the communication terminal apparatus increases gradually;

FIG. 8 is a table showing a relationship between the moving velocity of the communication terminal apparatus and an area size of position metadata to be acquired;

FIG. 9 is an explanatory diagram showing a specific example of position metadata acquisition processing;

FIG. 10 is an explanatory diagram showing a specific example of the position metadata acquisition processing;

FIG. 11 is an explanatory diagram showing a specific example of the position metadata acquisition processing;

FIG. 12 is an explanatory diagram showing a specific example of the position metadata acquisition processing; and

FIG. 13 is a flowchart showing an operation example of the position metadata acquisition processing.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elemehts is omitted.

Note that the description will be given in the following order.

1. Configuration of system

2. About position metadata

3. Functional configuration of system

4. Outline of metadata acquisition method
4-1. Example of when area size of metadata acquisition area is rendered variable
4-2. Example of when information density of metadata is rendered variable

5. Operation example of position metadata acquisition processing

6. Examples of effects

<1. Configuration of System>

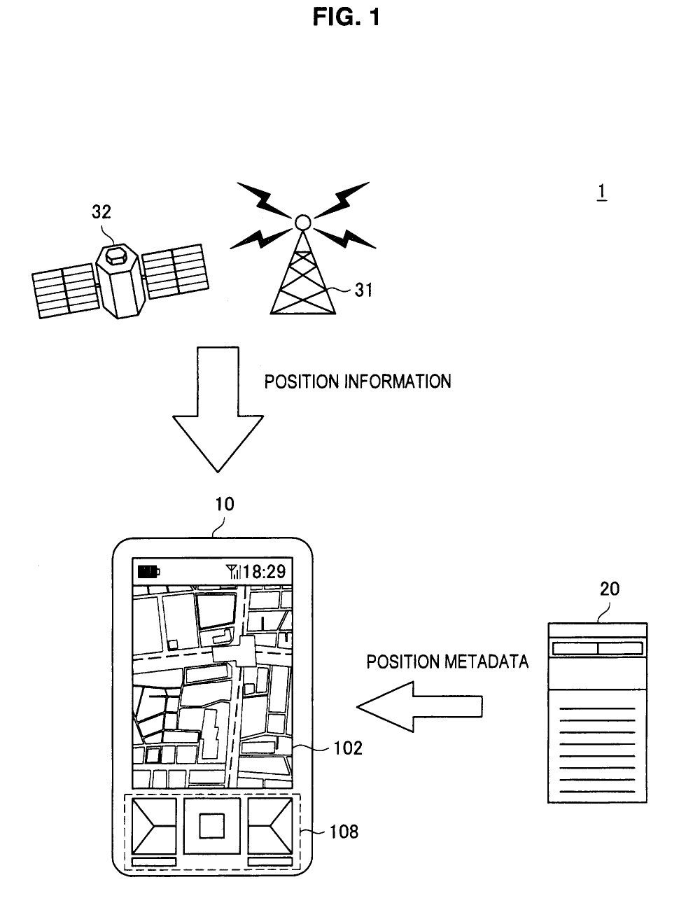

First, with reference to FIG. 1, a configuration of an information processing system according to an embodiment of the present invention will be described. FIG. 1 is a configuration diagram of the information processing system according to the embodiment of the present invention.

An information processing system 1 according to an embodiment of the present invention has a communication function, and mainly includes a communication terminal apparatus 10 which provides a user with information based on metadata related to a position (hereinafter, referred to as position metadata), a metadata providing server 20 which provides the communication terminal apparatus 10 with the position metadata, and a base station 31 or a GPS satellite 32 which is a position information providing apparatus for providing position information of the communication terminal apparatus 10.

The communication terminal apparatus 10 is capable of being connected to the metadata providing server 20, the base station 31, and the GPS satellite 32 via a network (not shown). The communication terminal apparatus 10 can acquire a current position of the communication terminal apparatus 10 based on position information acquired from the base station 31 or the GPS satellite 32, for example. The communication terminal apparatus 10 can acquire position metadata including map information of the surroundings of the acquired current position from the metadata providing server 20, and can provide the user with the map information of the surroundings of the current position and the position of the user on the map.

The metadata providing server 20 has functions of searching position metadata in response to an acquisition request for the position metadata based on the current position of the communication terminal apparatus 10 and providing the position metadata of the surrounding area. The metadata providing server 20 may extract position metadata that matches a condition from pieces of position metadata stored in a storage area which the metadata providing server 20 has inside thereof, and may transmit the position metadata to the communication terminal apparatus 10. Further, the metadata providing server 20 may acquire position metadata by cooperating with other external services (including Web services), and may generate position metadata which the communication terminal apparatus 10 is to be provided with.

<2. About Position Metadata>

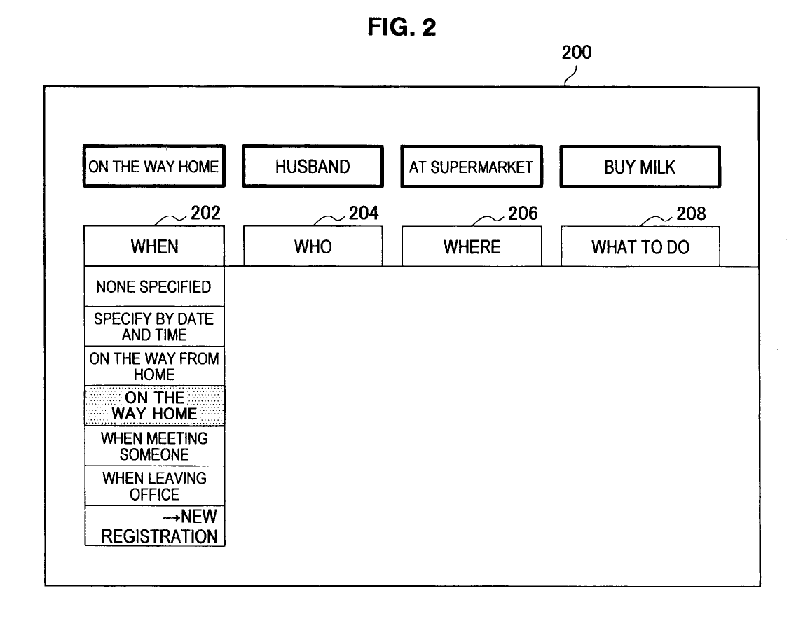

Here, with reference to FIGS. 2 to 4, the position metadata which the communication terminal apparatus 10 acquires and provides the user with will be described by showing an example of a service which the communication terminal apparatus 10 provides the user with. FIGS. 2 to 4 are each an explanatory diagram illustrating position metadata.

The position metadata provided by the communication terminal apparatus 10 mainly includes map information, POI (Point Of Interest) information, and user meta-information. Here, the POI information refers to spot information indicating a point of interest such as a restaurant and a resort facility. Examples of components of the POI information include a name, a latitude/longitude, an address, a genre, a telephone number, and a URI (Uniform Resource Identifier).

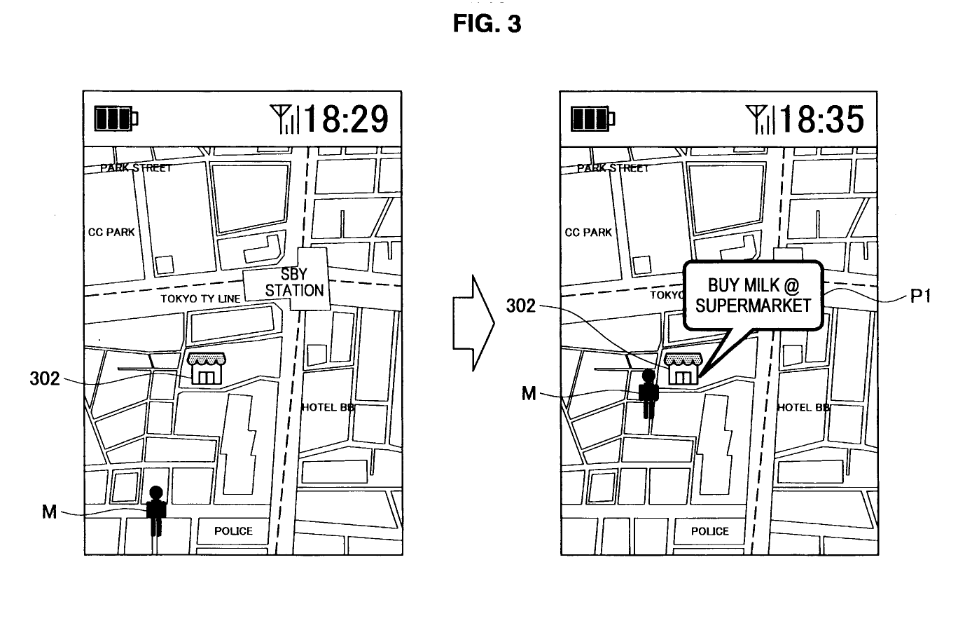

The user meta-information is information which is associated with the user and a position. A service which the communication terminal apparatus 10 may provide the user with may be information based on user information, which has been registered by the user beforehand by member registration. Based on the user information registered at that time, user metadata may be generated. Here, with reference to FIGS. 2 and 3, an example of the user meta-information will be described. FIG. 2 is an explanatory diagram showing an example of a setting screen 200 of the user metadata.

The setting screen 200 of the user metadata is a screen for setting information which the user wants to notify a notification target of in association with a position. The information to be set here is information in which “location” is set to an existing To-Do list (that is, things to do). The communication terminal apparatus 10 has a function of notifying the notification target of the set contents based on the user metadata and by using the set “location” as a trigger.

The setting screen 200 mainly includes a notification time setting area 202, a notification user setting area 204, a notification location setting area 206, and a notification content setting area 208, for example. The notification time setting area 202 is an area for setting notification time. The notification time indicates “when” is the time that the set user approaches a set location to cause the notification of the set contents to be performed. The notification user setting area 204 is an area for setting a user to be a notification trigger. The user to be a notification trigger indicates “who” is the person that approaches a set location to cause the notification of the set contents to be performed. The set user here is not only the trigger of the notification, but is also a notification target. When the user registers beforehand family as notification target users in the user information, it is possible to set in a manner to perform notification not only to the user who set the user metadata but also to other people such as the family. The notification location setting area 206 is an area for setting a location to be a notification trigger. The location to be a notification trigger indicates “where” is the location that the set user approaches to cause the notification of the set contents to be performed. As the notification location, there may be set unspecified supermarkets as in the present embodiment, or there may be set specified locations. The notification content setting area 208 is an area for setting contents which the set user is notified of in the case where the set user approaches a set location at a set time. As the notification contents, there may be set so-called To-Do list.

In the present embodiment, the case where notification conditions are set as following will be described. For example, the notification time is “on the way home”, the notification user is “husband”, the notification location is “at supermarket”, and the notification content is “buy milk”. FIG. 3 shows an example of a screen which has the above contents that the notification target is notified of. On the left diagram of FIG. 3, there are shown map information of the surroundings of the current position of the user and a current position M of the user. It can be seen that there is a supermarket 302 in the travelling direction of the user. Here, it is assumed that the user at the position indicated by the current position M represents the user who is expressed as “husband” in FIG. 2. After this, if the user approaches the supermarket 302, the notification content is displayed in a pop-up P1. A timing at which the notification target is notified of the notification content is when the distance from the location set as the notification location in the notification conditions to the current position M of the user becomes equal to or less than a predetermined threshold, for example.

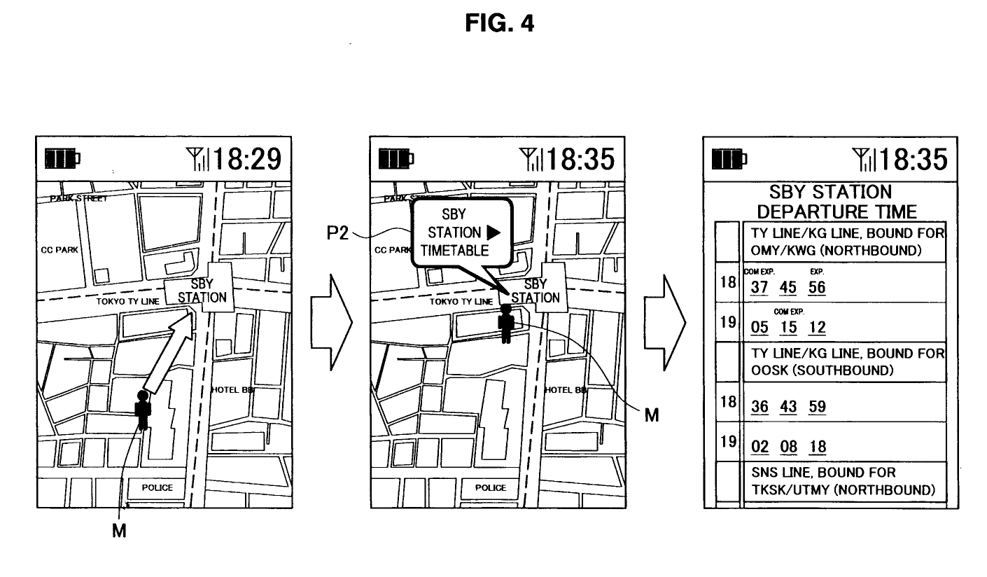

The information including the notification conditions and notification contents as described above is a kind of user metadata. In addition thereto, the following information is another kind of user metadata, for example. The left diagram of FIG. 4 shows map information of the surroundings of the current position of the user and a current position M of the user. It is assumed that the user is walking in the direction of SBY station. When the user approaches SBY station, as shown in the middle diagram of FIG. 4, a pop-up P2 which indicates a link to a train timetable of SBY station is displayed on the screen. When the user looks at the display on the screen and clicks the pop-up P2, the timetable of SBY station is displayed as shown in the right diagram of FIG. 4. In order to provide such a service, there can be used as an example of the user metadata, user information (for example, application registration information of the service which displays a timetable when approaching a station) which the user registered beforehand.

<3. Functional Configuration of System>

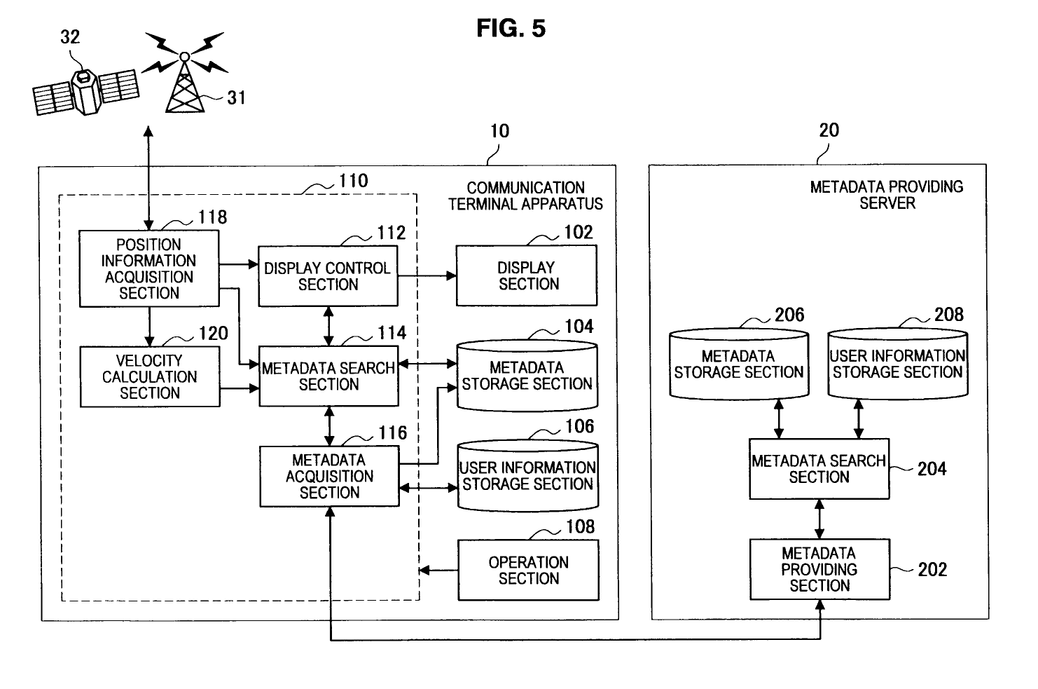

Next, with reference to FIG. 5, a functional configuration of an information processing system according to an embodiment of the present invention will be described. FIG. 5 is a functional block diagram of the information processing system according to the embodiment of the present invention.

(Functional Configuration of Communication Terminal Apparatus)

First, the communication terminal apparatus 10 mainly includes a display section 102, a metadata storage section 104, a user information storage section 106, an operation section 108, and a control section 110. In addition, the control section 110 mainly includes a display control section 112, a metadata search section 114, a metadata acquisition section 116, a position information acquisition section 118, and a velocity calculation section 120.

The display section 102 is a display device for displaying information for the user in accordance with the control of the display control section 112. The display section 102 includes a liquid crystal display (LCD) device, an OLED (Organic Light Emitting Diode) device, and a CRT (Cathode Ray Tube) display device, for example.

The metadata storage section 104 is a storage device for storing position metadata. The metadata storage section 104 which is provided inside the communication terminal apparatus 10 stores the position metadata of the surroundings of the location which is set beforehand, such as the residence and workplace of the user. Then, when the metadata acquisition section 116 acquires position metadata from the metadata providing server, the metadata storage section 104 stores the acquired position metadata.

The user information storage section 106 is a storage device which stores information related to the user of the communication terminal apparatus 10. The user information which is stored here may include, for example, preference information of the user and configuration information set by the user. As described above, the service, which the user is provided with in the present information processing system, is provided based on the information which is set by user registration beforehand. However, the service may also be used by a user who is not registered. In this case, the user information related to the registered user is stored in a user information storage section 208 of the metadata providing server 20. Then, the user information storage section 106 of the communication terminal apparatus 10 mainly stores the user information related to the unregistered user.

In the present embodiment, the metadata storage section 104 and the user information storage section 106 are shown as separate storage devices, but are not limited thereto. For example, the metadata storage section 104 and the user information storage section 106 may be implemented as a single storage device. Here, examples of the metadata storage section 104 and the user information storage section 106 include, but are not limited to, a magnetic recording medium such as an HDD (Hard Disk Drive), and a non-volatile memory such as an EEPROM (Electronically Erasable and Programmable Read Only Memory), a flash memory, an MRAM (Magnetoresistive Random Access Memory), a FeRAM (Ferroelectric Random Access Memory), and a PRAM (Phase change Random Access Memory).

The display control section 112 has a function of controlling the display of the display section 102, and generates a screen displayed on the display section 102. For example, the display control section 112 generates map data to be displayed from position metadata input from the metadata search section 114, and, based on position information of the communication terminal apparatus 10 acquired by the position information acquisition section 118, the display control section 112 generates a screen in which an icon indicating a current position of the communication terminal apparatus 10 is superimposed on the generated map data. Alternatively, in the case where the position metadata input from the metadata search section 114 includes user metadata, and when the current position of the communication terminal apparatus 10 approaches a location to be a notification trigger, the display control section 112 also has functions of extracting a notification content from the user metadata and causing the display section 102 to display the notification content. Further, the display control section 112 can also change the scale and range of the map to be displayed on the display section 102, in accordance with operation information input by the user using the operation section 108.

The metadata search section 114 has a function of searching position metadata stored in the metadata storage section 104, which is provided inside the communication terminal apparatus 10, in accordance with the instruction from the display control section 112. For example, based on the current position acquired by the position information acquisition section 118, the metadata search section 114 searches the internal metadata storage section 104 for position metadata to be displayed on the display section 102 by the display control section 112. In the case where desired data exists in the metadata storage section 104, the metadata search section 114 inputs the position metadata extracted from the metadata storage section 104 to the display control section 112. On the other hand, in the case where the desired data is absent in the metadata storage section 104, the metadata search section 114 causes the metadata acquisition section 116 to acquire the position metadata from an external metadata providing server 20.

The metadata acquisition section 116 has functions of acquiring position metadata from the metadata providing server and causes the acquired position metadata to be stored in the metadata storage section 104 provided inside the communication terminal apparatus 10. At that time, the metadata acquisition section 116 transmits an acquisition request including acquisition conditions for acquiring the position metadata to the metadata providing server 20. The acquisition conditions transmitted here may include information for specifying a range of an acquisition area of the position metadata, such as a reference point to be a reference of the acquisition area of the position metadata (for example, the central point on the acquisition area) and an area size indicating the size of the acquisition area. The area size is determined by the metadata acquisition section 116 depending on the moving velocity of the communication terminal apparatus 10. Further, the metadata acquisition section 116 determines the reference point based on the current position information acquired by the position information acquisition section 118. For example, the metadata acquisition section 116 may determine a current position at the point of starting the position metadata acquisition processing as the reference point, and may also determine a point, which is estimated from the current position at the point of starting the position metadata acquisition processing and a moving velocity (including moving direction), as the reference point.

In addition to the acquisition conditions, the metadata acquisition section 116 may transmit information for identifying the user to the metadata providing server 20. Alternatively, in the case where the metadata acquisition section 116 generates acquisition conditions of the position metadata based on user information held by the communication terminal apparatus 10 itself, the metadata acquisition section 116 may transmit the generated acquisition conditions to the metadata providing server 20.

Further, although as will be described in detail later, the metadata acquisition section 116 selectively acquires the position metadata as necessary. For example, the metadata acquisition section 116 selectively acquires position metadata from within the acquisition area based on at least one of the position information acquired by the position information acquisition section 118 and the user information stored in the user information storage section 106 beforehand.

Further, for example, the metadata acquisition section 116 selectively acquires position metadata of a necessary category from within the acquisition area based on an attribute of a region specified by the position information acquired by the position information acquisition section 118.

Still further, for example, the metadata acquisition section 116 estimates transportation means of the user based on the moving velocity of the communication terminal apparatus 10 and the position information acquired by the position information acquisition section 118, and selectively acquires position metadata from within the acquisition area depending on the estimated transportation means.

In addition, for example, the metadata acquisition section 116 selectively acquires position metadata from within the acquisition area in accordance with the preference information included in the user information which is registered beforehand or the preference information based on action history information of the user.

The position information acquisition section 118 is a functional section which acquires the position information indicating the current position. For example, the position information acquisition section 118 may include: a GPS receiver which receives GPS signals transmitted from GPS satellites that revolve around the earth; and a current position calculation section which calculates positions of respective GPS satellites from orbital information included in the received GPS signals, and which calculates a current position based on the calculated positions of the GPS satellites and the difference between the transmission time and the reception time of the GPS signals. Alternatively, the position information acquisition section 118 may include: a receiver which receives WiFi radio waves from multiple base stations; and a current position calculation section which estimates distances from the respective base stations based on the reception strength of the received WiFi radio waves, and which calculates a current position based on the triangulation principle using the distances from the respective base stations and the positions of the respective base stations. Still further, the position information acquisition section 118 may calculate the current position from the positioning data obtained by using various sensors.

The velocity calculation section 120 has a function of calculating a moving velocity from variations in amount and time of the position information acquired by the position information acquisition section 118. A history of the position information is temporarily stored in a memory section (not shown) and the like. The velocity calculation section 120 can calculate, from the history information, a travelling direction in addition to the moving velocity.

(Functional Configuration of Metadata Providing Server)

Next, the metadata providing server 20 mainly includes a metadata providing section 202, a metadata search section 204, a metadata storage section 206, and a user information storage section 208.

The metadata providing section 202 has functions of receiving the acquisition request for the position metadata from the communication terminal apparatus 10, causing the metadata search section 204 to search the position metadata in response to the acquisition request, and transmitting the acquired position metadata to the communication terminal apparatus 10.

The metadata search section 204 searches the position metadata based on the acquisition request for the position metadata input from the metadata providing section 202. At that time, in the case where identification information of the user is included in the acquisition request, the metadata search section 204 refers to user information stored in the user information storage section 208 as necessary. Further, the metadata search section 204 may search not only metadata stored in the metadata storage section 206 provided inside the metadata providing server 20, but also metadata stored in another device (not shown).

The metadata storage section 206 is a storage device which stores the position metadata. The metadata storage section 206 stores pieces of position metadata to be provided in response to the request from each communication terminal apparatus 10. When compared to the case where entire pieces of position metadata are held inside each communication terminal apparatus 10, the case where the communication terminal apparatus 10 acquires position metadata from the metadata providing server 20 on a case-by-case basis is more preferred, because when updating of the contents in the position metadata is necessary, the updating can be reflected immediately only by updating the information in the metadata providing server.

The user information storage section 208 is a storage device which stores information related to the user of each communication terminal apparatus 10. The user information stored here may include, for example, configuration information set by the user and history information and preference information of the user. As described above, the service, which the user is provided with in the present information processing system, is provided based on the information which is set by user registration beforehand. The user information stored in the user information storage section 208 is used to provide the registered user with more detailed services.

In the present embodiment, the metadata storage section 206 and the user information storage section 208 are shown as separate storage devices, but are not limited thereto. For example, the metadata storage section 206 and the user information storage section 208 may be implemented as a single storage device. Here, examples of the metadata storage section 206 and the user information storage section 208 include, but are not limited to, a magnetic recording medium such as an HDD (Hard Disk Drive), and a non-volatile memory such as an EEPROM (Electronically Erasable and Programmable Read Only Memory), a flash memory, an MRAM (Magnetoresistive Random Access Memory), a FeRAM (Ferroelectric Random Access Memory), and a PRAM (Phase change Random Access Memory).

<4. Outline of Metadata Acquisition Method>

The communication terminal apparatus 10 according to the present embodiment has a feature in the acquisition method of the position metadata. This point will be described in further detail.

Among pieces of position metadata which are used for providing a user with information, the communication terminal apparatus 10 stores position metadata of the surroundings of a point (for example, a point registered as a default point) in the storage area provided inside thereof. Then, the position metadata other than the areas of the stored position metadata is acquired from the metadata providing server 20 connected thereto via a network on a case-by-case basis. For example, in devices whose purposes are limited, as in the case of navigation devices, there are devices which store entire pieces of position metadata therein. However, in terminal apparatuses each having many functions such as mobile phones, it is difficult for many of the terminal apparatuses to ensure enough capacity in the storage areas for position metadata. Further, if the network band is sufficient, it is possible to acquire large amounts of position metadata, but in the present circumstances, sufficient network band is not necessarily ensured.

Accordingly, a method of efficiently acquiring position metadata is desired. Therefore, there are suggested two approaches for enhancing efficiency of position metadata acquisition in the communication terminal apparatus 10. The first approach is to adjust the area size of the position metadata to be acquired depending on a moving velocity of the communication terminal apparatus 10. For example, in the case where the user of the communication terminal apparatus 10 is travelling on foot, it is highly likely that the user wants detailed map information, and hence, the range of area of the position metadata acquired at one time may be smaller compared to the range of area of the position metadata acquired in the case of travelling by transportation means such as a car and a train. On the other hand, in the case where the user is travelling by transportation means such as a car and a train, it is highly likely that the user wants wide-area map information, and hence, it is preferred that the range of area of the position metadata acquired at one time be larger compared to the range of area of the position metadata acquired in the case where the user travels on foot. Accordingly, the communication terminal apparatus 10 increases the size of the acquisition area of the position metadata acquired at one time as the moving velocity of the communication terminal apparatus 10 becomes higher.

In addition, the second approach is to adjust a granularity of the position metadata to be acquired. The entire information in the position metadata may not be necessarily required. The required information differs depending on the user or the situation which the user is in. More specifically, a density of the required position metadata differs depending on the transportation means of the user having the communication terminal apparatus 10. Consequently, the metadata acquisition section 116 selectively acquires the position metadata based on at least one of the position information of the communication terminal apparatus 10 and the user information which is registered beforehand.

[4-1. Example of when Area Size of Metadata Acquisition Area is Rendered Variable]

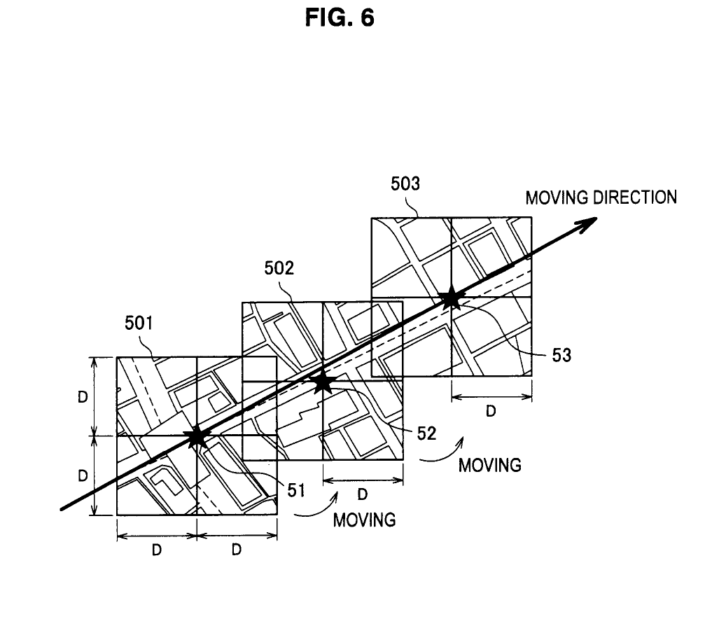

Here, the two approaches for efficiently acquiring the position metadata will be described below by using specific examples of the approaches. First, an area size determined by the metadata acquisition section 116 will be described using FIGS. 6 to 8. FIG. 6 is an explanatory diagram illustrating a method of acquiring position metadata in the case where a moving velocity of the communication terminal apparatus 10 is constant.

First, it is assumed that the communication terminal apparatus 10 holds information indicated by position metadata 501 in the internal metadata storage section 104. Then, as the user moves and when the position metadata to be displayed is not present any more in the internal metadata storage section 104, the metadata acquisition section 116 acquires position metadata 502 from the metadata providing server 20. At this time, the metadata acquisition section 116 transmits acquisition conditions for specifying the range of the position metadata 502 to be acquired to the metadata providing server 20. The acquisition conditions include, for example, a reference point 52 of an area of the position metadata to be acquired and an area size D indicating the size of an acquisition area. The acquisition area refers to a square area whose center is the reference point 52 and whose side is 2D, for example. As shown in FIG. 6, in the case where the moving velocity of the communication terminal apparatus 10 is constant, the area size is the same for each acquisition area.

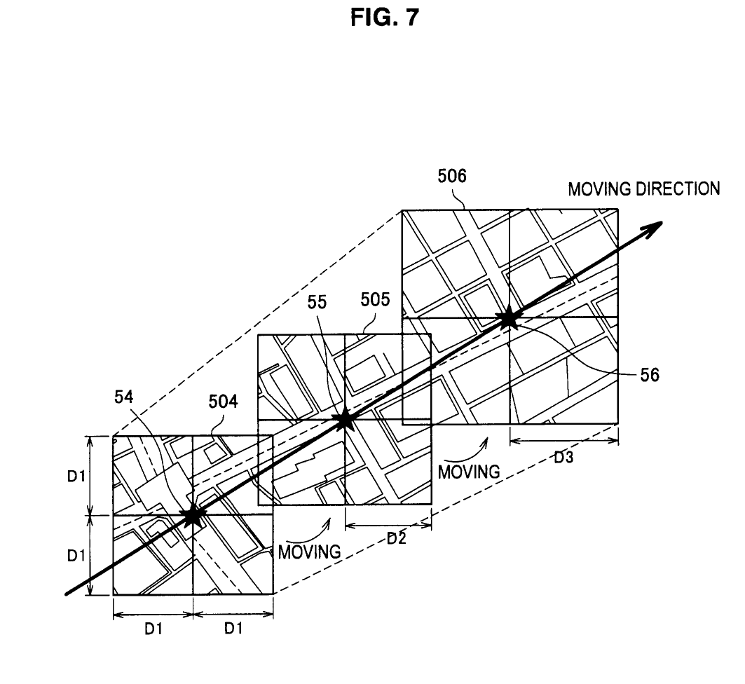

On the other hand, FIG. 7 shows a method of acquiring position metadata in the case where the moving velocity of the communication terminal apparatus 10 increases gradually. The metadata acquisition section 116 determines the area size of the acquisition area of the position metadata based on a moving velocity at the time of performing acquisition processing of the position metadata. In the example shown in FIG. 7, the moving velocity of the communication terminal apparatus 10, which the user in a car has, increases gradually as the car accelerates from a reference point 54 of position metadata 504, and hence, the metadata acquisition section 116 enlarges the area size of the position metadata to be acquired depending on the moving velocity.

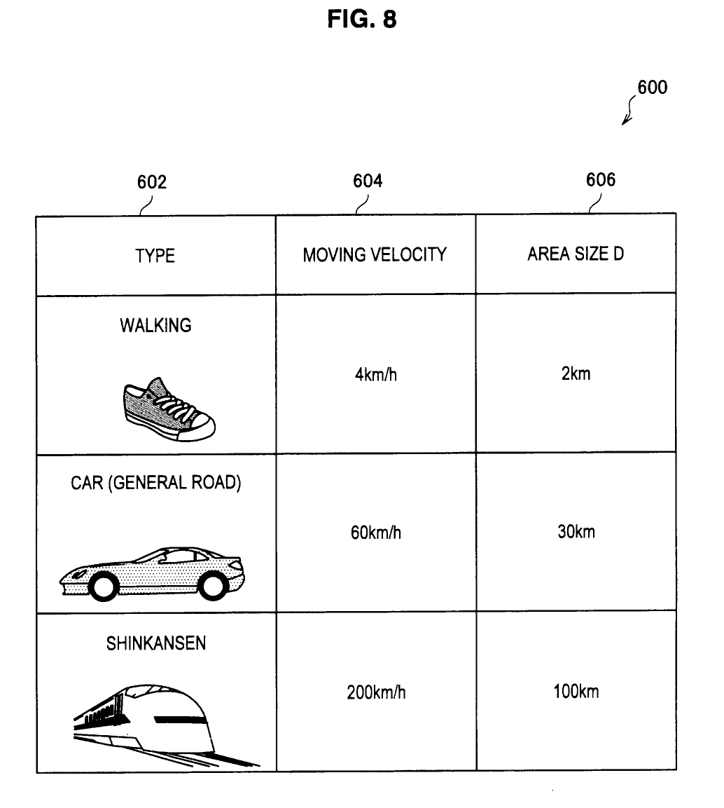

FIG. 8 shows an example of the area size D which is actually used. FIG. 8 is a table showing a relationship between the moving velocity of the communication terminal apparatus and an area size of position metadata to be acquired. For example, in the case where the user having the communication terminal apparatus 10 is travelling on foot and the moving velocity of the user is 4 km/h, the value of the area size D is 2 km. Further, in the case where the user having the communication terminal apparatus 10 is travelling by car, or a car on which the communication terminal apparatus 10 is mounted is moving, and the moving velocity of the communication terminal apparatus 10 is 60 km/h, the value of the area size D is 30 km. Further, in the case where the user having the communication terminal apparatus 10 is travelling on Shinkansen and the moving velocity is 200 km/h, the value of the area size D is 100 km.

As described above, when the area size of the position metadata to be acquired is rendered variable depending on the moving velocity of the communication terminal apparatus 10, there can be achieved metadata acquisition with good efficiency. However, in the case where the area size is large, that is, in the case where the moving velocity is high, the data amounts to be acquired becomes too large by simply changing the size. Consequently, as the second approach, there can be considered a way in which the information density of the position metadata to be acquired is rendered variable. Hereinafter, the second approach will be described by using specific examples.

[4-2. Example of when Information Density of Metadata is Rendered Variable]

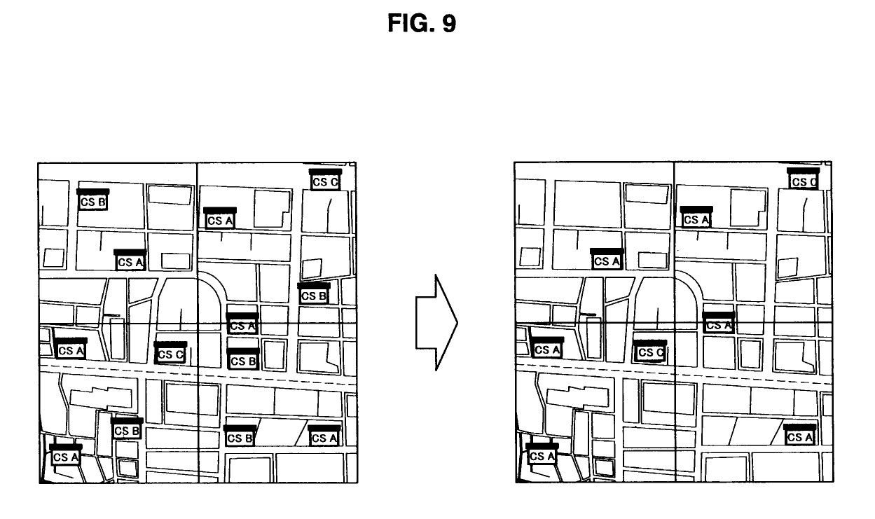

Next, with reference to FIGS. 9 to 12, there will be described a method of achieving metadata acquisition with good efficiency by rendering the information density of the position metadata variable.

First, referring to FIG. 9, the left diagram includes POI information of all convenience stores within the acquisition area. However, for example, in the case where the user rarely uses convenience stores B among convenience stores A, convenience stores B, and convenience stores C, the information related to the positions of the convenience stores B is unnecessary for the user. In this case, the metadata acquisition section 116 of the communication terminal apparatus 10 selectively acquires the POI information of the convenience stores A and the convenience stores C. Accordingly, the data amounts of the POI information to be acquired can be reduced, and hence, there is an advantage that the efficiency is enhanced.

Such an acquisition method may be achieved by the following configuration. For example, the metadata acquisition section 116 determines selection conditions of metadata based on preference information of user information stored in the user information storage section 106 of the communication terminal apparatus 10. Then, the metadata acquisition section 116 adds the selection conditions to the acquisition conditions of metadata and transmits the selection conditions and the acquisition conditions to the metadata providing server 20. The metadata search section 204 of the metadata providing server 20 executes a search in accordance with the selection conditions and the acquisition conditions. Alternatively, such an acquisition method may be achieved by the following configuration. The user information, which is stored in the user information storage section 208 provided inside the metadata providing server 20, is set to selectively acquire position metadata. In this case, the metadata search section 204 selectively acquires the position metadata based on the user information.

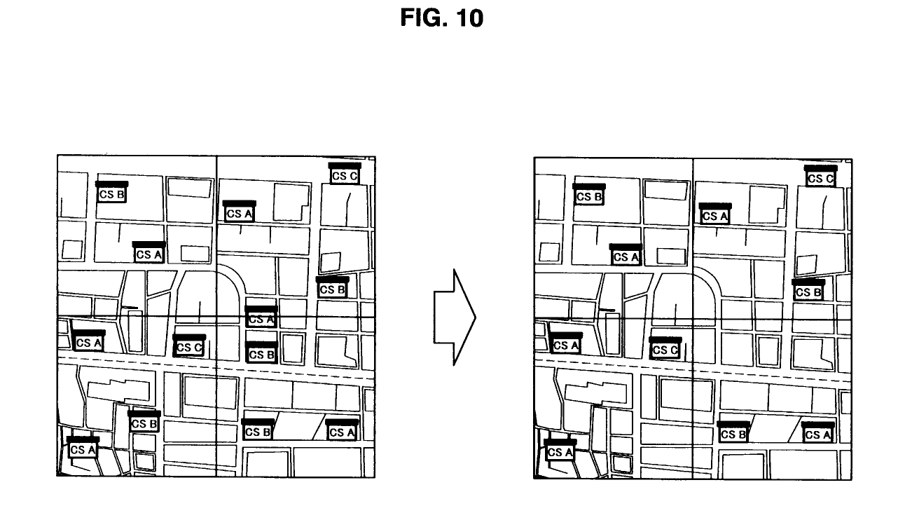

Next, referring to FIG. 10, the left diagram includes POI information of all convenience stores within the acquisition area in the same manner as FIG. 9. However, in the case where too many convenience stores are closely located with each other, not every piece of information may be necessary. Consequently, the metadata acquisition section 116 of the communication terminal apparatus 10 may selectively acquire the POI information in a manner that convenience stores are located at regular intervals. At that time, the metadata search section 204 acquires the position information of the convenience stores and applies an existing algorithm to the position information, to thereby acquire the POI information in a manner that the positions of the convenience stores are located at regular intervals.

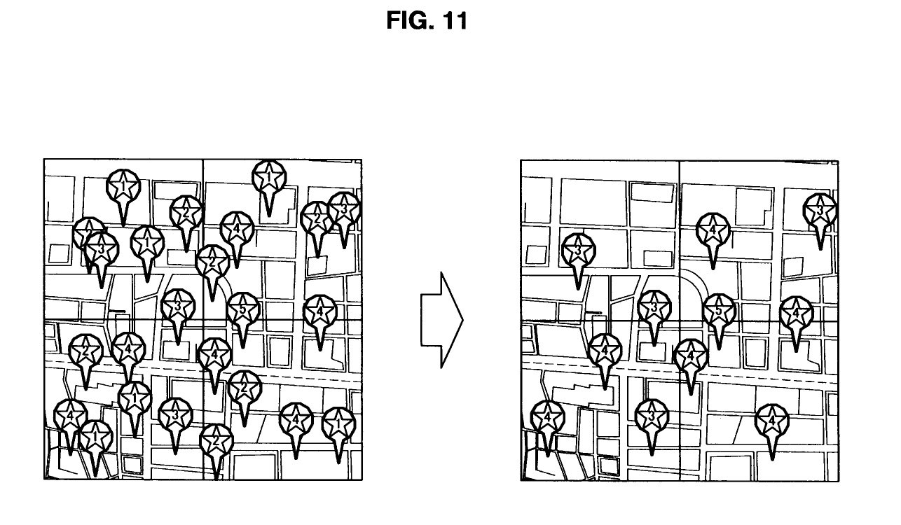

Next, referring to FIG. 11, the left diagram includes POI information of all restaurants within the acquisition area. Here, a numeral written inside a star pointing a restaurant shows the evaluation of the restaurant based on a word-of-mouth site. It can be considered that a user who refers to a word-of-mouth site having the score for the restaurant is looking for a restaurant which has good word-of-mouth evaluation. That is, it is highly likely that information with a low score is unnecessary for the user. Therefore, the metadata acquisition section 116 of the communication terminal apparatus 10 may only acquire the POI information which corresponds to the restaurants each having a score of equal to or more than a predetermined threshold. As an example, the right diagram shows a diagram in which restaurants whose scores are 3 or more are shown. It is preferred that only the necessary information be shown in this way, because the probability of the user reaching the desired information is higher and it is easier for the user to view.

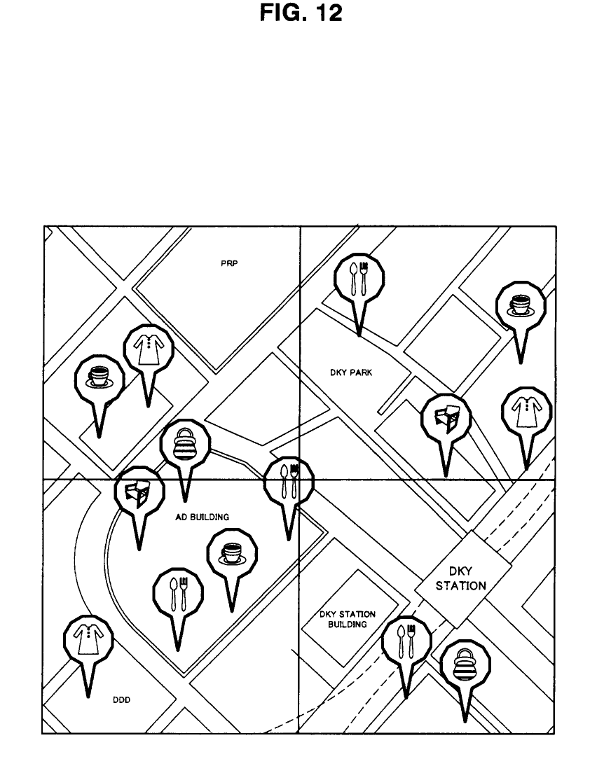

Further, referring to FIG. 12, there is shown a diagram selectively displaying the pieces of POI information of necessary categories from among the pieces of POI information within the acquisition area, based on an attribute of the region of the acquisition area. For example, it is assumed that the surroundings of DKY station are famous for its many interior shops and boutiques, and great number of people who visit there for shopping and the like. In this case, the pieces of POI information related to interior shops, restaurants, cafes, and boutiques are selectively acquired, and the pieces of information related to schools and hospitals are not acquired. In this way, the metadata acquisition section 116 may estimate a category of information which the user may require based on the attribute of the region, and may selectively acquire only the necessary information. The metadata search section 204 of the metadata providing server 20 may determine the required category by referring to a database in which an attribute of a location and a required category are associated with each other, for example. In addition, for example, in the case where the user works near DKY station, there is a case where a required category differs from a general category. In this manner, the metadata search section 204 may estimate the purpose of the user being at the location by referring to information unique to the user from the user information storage section 208, and may determine the required category.

Specifically, the metadata providing server 20 is configured to be capable of referring to tag information which is associated with the location beforehand. The tag information may be imparted manually by a person, or may be imparted by collective intelligence using a CGM (Consumer Generated Media). For example, it is assumed that there are imparted tags of “weekend”, “fashion”, “miscellaneous goods”, “lunch”, “cafe”, and “beauty shop” to the above-mentioned DKY station. On the other hand, it is assumed that there are imparted tags of “weekday (9:00 to 17:30)”, “lunch”, “convenience store”, “ATM”, “post office”, “bank”, and “pharmacy” with respect to the workplace. Here, it is assumed that a user A who works near DKY station registers the location of the workplace (address or latitude/longitude) in the metadata providing server 20. In this case, when the user A walks the surroundings of DKY station between 9:00 and 17:30 of a weekday, the metadata search section 204 of the metadata providing server 20 refers to, based on the time and the place, the latter set of tags which are associated with the workplace, and preferentially acquires the POI information related to “lunch”, “convenience store”, “ATM”, “post office”, “bank”, and “pharmacy”. On the other hand, when the user A walks the surroundings of DKY station on a weekend or on the way home from work (when it is after 17:30 and the user A is a certain distance away from the workplace, the communication terminal apparatus 10 provides the metadata providing server 20 with a notification and determines that the user A is on the way home from work), the metadata search section 204 refers to, based on the time and the place, the former set of tags which are associated with DKY station, and preferentially acquires the POI information related to “fashion”, “miscellaneous goods”, “lunch”, “cafe”, and “beauty shop”.

In addition, the metadata acquisition section 116 may estimate, based on the moving velocity and the position information of the communication terminal apparatus 10, the current state of the user, for example, the transportation means which indicates whether the user is walking, running, being on a train, being on Shinkansen, or being on a car, and may selectively acquire required position metadata depending on the transportation means. For example, in the case where the user is on a running train, it is difficult to visit a convenience store or a supermarket even though there are pieces of information indicating convenience stores or supermarkets near the current position, and hence, the metadata acquisition section 116 may not acquire such pieces of POI information.

The method of rendering the information density of the position metadata variable has been described by referring to four examples shown in FIGS. 9 to 12, and the four examples can be achieved by: the metadata acquisition section 116 of the communication terminal apparatus 10 referring user information stored in the user information storage section 106; or the metadata acquisition section 116 generating acquisition conditions based on operation information input from the operation section 108 and transmitting the generated acquisition conditions to the metadata providing server, and the metadata search section 204 of the metadata providing server 20 searching position metadata based on such acquisition conditions. Alternatively, in the case where the communication terminal apparatus 10 is possessed by a registered user, the method may also be achieved by the metadata search section 204 of the metadata providing server 20 referring to the user information stored in the user information storage section 208, adding more acquisition conditions, and searching position metadata based on such acquisition conditions.

Further, in the case of selectively acquiring the position metadata, it may be set in a manner that, among pieces of position metadata, the POI information which is associated with user metadata is acquired without fail, for example. For example, in the case where there is user metadata associated with a supermarket, “buy milk at a supermarket on the way home”, the POI information of the supermarket is acquired without fail.

<5. Operation Example of Position Metadata Acquisition Processing>

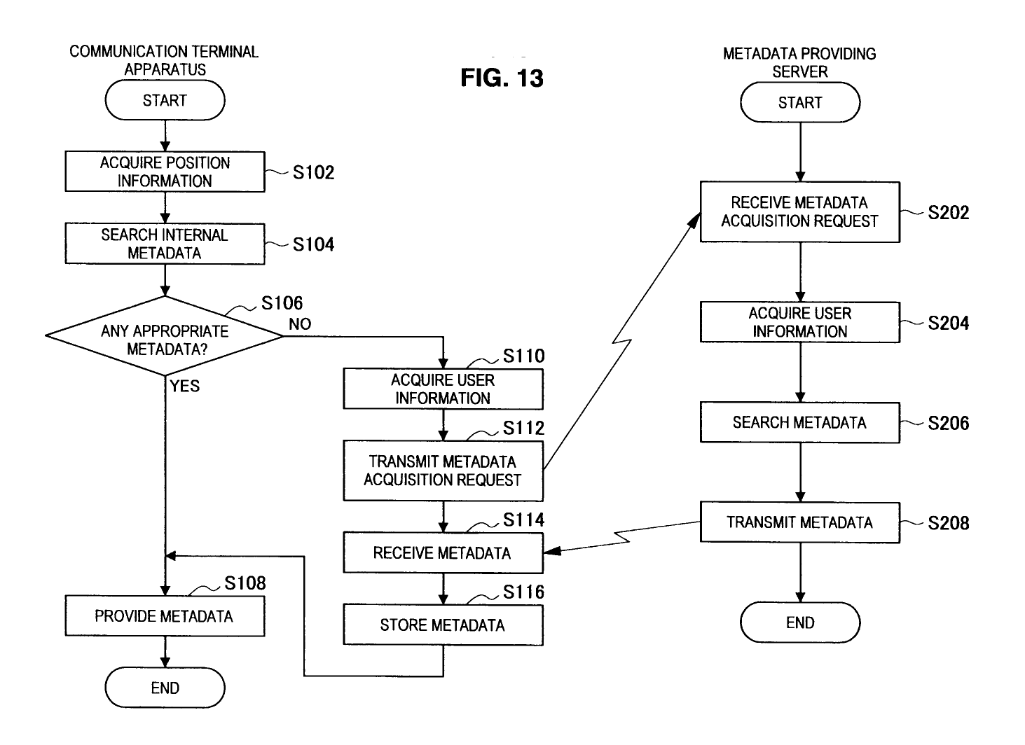

Next, with regard to the position metadata acquisition processing that has been described above, an operation example thereof will be described by using a flowchart of FIG. 13. FIG. 13 is a flowchart showing an operation example of the position metadata acquisition processing.

First, the position information acquisition section 118 of the communication terminal apparatus 10 acquires the current position of the communication terminal apparatus 10 (S102). After that, the metadata search section 114 searches the internal metadata storage section 104 for position metadata of the surroundings of the current position (S104) and then determines whether or not there is appropriate metadata (S106). In the determination, in the case where it is determined that there is appropriate position metadata, the metadata search section 114 inputs the appropriate position metadata to the display control section 112, and the display control section 112 generates information based on the input position metadata and causes the display section 102 to display the information, to thereby provide the user with the information (S108).

On the other hand, in the case where there is not appropriate metadata in the internal metadata storage section 104, the metadata search section 114 causes the metadata acquisition section 116 to acquire the appropriate position metadata from the external metadata providing server 20. At that time, the metadata search section 114 inputs the position information acquired by the position information acquisition section 118 and the moving velocity calculated by the velocity calculation section 120 to the metadata acquisition section 116.

The metadata acquisition section 116 further acquires user information from the user information storage section 106 (S110), and generates acquisition conditions of the position metadata from the acquired user information. Then, a metadata acquisition request including the generated acquisition conditions is transmitted to the metadata providing server 20 (S112).

The metadata providing server 20 receives the position metadata acquisition request transmitted from the communication terminal apparatus 10 (S202), and here, the metadata providing server 20 acquires, by the metadata search section 204, user information stored in the metadata providing server 20 (S204), and re-generates as necessary acquisition conditions from the acquisition conditions included in the acquisition request and the user information. Then, the metadata search section 204 searches position metadata based on the acquisition conditions generated here (S206). After that, the metadata search section 204 inputs the retrieved position metadata to the metadata providing section 202, and the metadata providing section 202 transmits the input position metadata to the communication terminal apparatus 10 (S208).

The metadata acquisition section 116 of the communication terminal apparatus 10 receives the position metadata transmitted from the metadata providing server 20 (S114), and causes the received position metadata to be stored in the metadata storage section 104 (S116). Then, from among the stored pieces of position metadata, the metadata search section 114 acquires necessary position metadata and inputs the position metadata to the display control section 112. The display control section 112 generates information based on the input position metadata and causes the display section 102 to display the information, to thereby provide the user with the information (S108).

<6. Examples of Effects>

As described above, according to the information processing system of the present embodiment, since the communication terminal apparatus acquires position metadata within the acquisition area having the area size depending on the moving velocity, acquisition of position metadata of a redundantly large region can be suppressed and there can be realized position metadata acquisition with good efficiency. In addition, because the position metadata can be acquired efficiently, the responsiveness of a screen which the user is provided with based on the acquired position metadata is also enhanced.

Further, by rendering the information density within the acquisition area variable depending on the user or the situation which the user is in, the information necessary for the user of the communication terminal apparatus can be preferentially acquired, and the data amounts to be acquired can be reduced. In this way, when the data amounts to be acquired are reduced, the load on the position metadata acquisition processing is also reduced, and there is also an effect that light operation of a service can be realized.

Note that the functions of respective sections of the communication terminal apparatus 10 described in the above embodiment are realized actually by an arithmetic unit (not shown) such as a CPU (Central Processing Unit) reading out a control program from a storage medium such as a ROM (Read Only Memory) or a RAM (Random Access Memory) that stores the control program in which a processing procedure for realizing those functions are written, interpreting the program, and executing the program. For example, in the communication terminal apparatus 10 according to the embodiment above, respective functions of the display control section 112, the metadata search section 114, the metadata acquisition section 116, the velocity calculation section 120, and a part of the position information acquisition section 118 are achieved actually by the CPU executing the program in which the processing procedure for realizing those functions are written.

It should be understood by those skilled in the art that various modifications, combinations, sub-combinations and alterations may occur depending on design requirements and other factors insofar as they are within the scope of the appended claims or the equivalents thereof.

For example, in the embodiment above, the case where the communication terminal apparatus is a mobile phone has been described, but the present invention is not limited to such an example. For example, the communication terminal apparatus may be any as long as the communication terminal apparatus has a function of acquiring the position information of the communication terminal apparatus, such as a portable game device, a portable music reproduction device, a PDA, a PC, a camera, and a navigation device.

Further, for example, in the embodiment above, although the communication terminal apparatus is configured to determine an area size depending on a moving velocity, the present invention is not limited to such an example. For example, the communication terminal apparatus may be configured to transmit the moving velocity to the metadata providing server, and the metadata providing server may be configured to determine the area size. Alternatively, the communication terminal apparatus may be configured to transmit the position information of the communication terminal apparatus to the metadata providing server, and the metadata providing server may be configured to calculate the moving velocity and determine the area size.

Note that in the present specification, the steps written in the flowchart may of course be processed in chronological order in accordance with the stated order, but may not necessarily be processed in the chronological order, and may be processed individually or in a parallel manner. It is needless to say that, in the case of the steps are processed in the chronological order, the order of the steps may be changed appropriately according to circumstances.

The present application contains subject matter related to that disclosed in Japanese Priority Patent Application JP 2010-000604 filed in the Japan Patent Office on Jan. 5, 2010, the entire content of which is hereby incorporated by reference.

What is claimed is:

1. A communication terminal apparatus comprising:
a position information acquisition section which acquires position information indicating a current position;
a velocity calculation section which calculates a moving velocity based on variations in amount and time of the position information acquired by the position information acquisition section; and
a metadata acquisition section which determines a reference point to be a reference of an acquisition area of position metadata based on the position information and the moving velocity, determines an area size indicating a size of the acquisition area depending on the moving velocity, and acquires position metadata within an acquisition area specified based on the reference point and the area size from a metadata providing server that provides position metadata.

2. The communication terminal apparatus according to claim 1,
wherein the position metadata includes at least information of a map and spot information which is information related to a point on the map, and
wherein the metadata acquisition section selectively acquires the spot information from among pieces of spot information within the acquisition area based on at least one of the position information and user information registered beforehand.

3. The communication terminal apparatus according to claim 2,
wherein the metadata acquisition section selectively acquires the spot information of a necessary category from among the pieces of spot information within the acquisition area based on an attribute of a region specified by the position information acquired by the position information acquisition section.

4. The communication terminal apparatus according to claim 2,
wherein the position metadata further includes user meta-information which is associated with a position and the user information, and
wherein the metadata acquisition section estimates transportation means of a user based on the moving velocity calculated by the velocity calculation section and the position information acquired by the position information acquisition section, and selectively acquires position metadata from within the acquisition area depending on the estimated transportation means.

5. The communication terminal apparatus according to claim 4,
wherein the metadata acquisition section selectively acquires the position metadata from within the acquisition area in accordance with preference information included in the user information registered beforehand or preference information based on action history information of the user.

6. A program for causing a computer to function as
a position information acquisition section which acquires position information indicating a current position,
a velocity calculation section which calculates a moving velocity based on variations in amount and time of the position information acquired by the position information acquisition section, and
a metadata acquisition section which determines a reference point to be a reference of an acquisition area of position metadata based on the position information and the moving velocity, determines an area size indicating a size of the acquisition area depending on the moving velocity, and acquires position metadata within an acquisition area specified by the reference point and the area size from a metadata providing server that provides position metadata.

7. An information processing system comprising:
a communication terminal apparatus which includes
a position information acquisition section which acquires position information indicating a current position,
a velocity calculation section which calculates a moving velocity based on variations in amount and time of the position information acquired by the position information acquisition section, and
a metadata acquisition section which determines a reference point to be a reference of an acquisition area of position metadata based on the position information and the moving velocity, determines an area size indicating a size of the acquisition area depending on the moving velocity, and acquires position metadata within an acquisition area specified by the reference point and the area size from a metadata providing server that provides position metadata; and
a metadata providing server which includes
a metadata search section which searches position metadata in accordance with a request of the metadata acquisition section, and
a metadata providing section which provides the communication terminal apparatus with position metadata, which is a result searched by the metadata search section.

8. A metadata providing server comprising:
a metadata search section which determines an area size indicating a size of an acquisition area of position metadata depending on a moving velocity of a communication terminal apparatus received from the communication terminal apparatus, and searches position metadata within an acquisition area specified based on a reference point received from the communication terminal apparatus and the area size; and
a metadata providing section which provides the communication terminal apparatus with position metadata, which is a result searched by the metadata search section.
